(19) United States
(12) Patent Application Publication
(10) Pub. No.: US 2016/0239770 A1
(43) Pub. Date: Aug. 18, 2016

(54) METHOD AND SYSTEM FOR DYNAMICALLY CHANGING PROCESS FLOW OF A BUSINESS PROCESS

(71) Applicants: Ritwik BATABYAL, Bangalore (IN); Anurag SRIVASTAVA, Bangalore (IN); Tekkethalakal KURIEN, Bangalore (IN)

(72) Inventors: Ritwik BATABYAL, Bangalore (IN); Anurag SRIVASTAVA, Bangalore (IN); Tekkethalakal KURIEN, Bangalore (IN)

(73) Assignee: Wipro Limited, Bangalore (IN)

(21) Appl. No.: 14/672,165

(22) Filed: Mar. 28, 2015

(30) Foreign Application Priority Data
Feb. 13, 2015 (IN) 722/CHE/2015

(51) Int. Cl. G06Q 10/06; G06F 9/54

(52) U.S. Cl. CPC G06Q 10/0633; G06F 9/542

(57) ABSTRACT

A method and system for dynamically modifying a process flow associated with an end to end process is disclosed. The method comprises receiving a trigger event associated with the end to end process; monitoring at least one process state resulting from the at least one trigger event; determining at least one of a user context, a process-event context, a process context, and an environment context for the at least one process state on detecting the at least one trigger event; defining, dynamically one or more configurable business rules based on the at least one of the user context, the process-event context, the process context, and the environment context using artificial intelligence and machine learning; and performing a process state change based on the one or more configurable business rules.

### PRIORITY CLAIM

This U.S. patent application claims priority under 35 U.S.C. §119 to Indian Application No. 722/CHE/2015, filed on Feb. 13, 2015. The aforementioned application is incorporated herein by reference in its entirety.

### TECHNICAL FIELD

This disclosure relates generally to business process management, and more particularly to a method and system for dynamically modifying the process flow of a business process.

### BACKGROUND

Business process management (BPM) focuses on improving corporate performance by managing and optimizing an organization's business processes. Business processes defined by business process models in modern systems typically define several process steps. Many business processes have evolved from single-enterprise business processes into inter-connected and networked business processes involving numerous, geographically-distributed business entities. The execution of a complete business process model may take an extended period of time, include different manual activities, and involve more than one business entity. For example, many organizations may need to automate business processes that involve large number of activities that span multiple systems and applications.

Business process systems have become increasingly prevalent in many organizations in managing various business processes. BPM systems enable enterprises to increase productivity, performance, profits, decrease inefficiency due to various factors and otherwise optimize various tasks. However, in existing BPM systems, the processes typically follow paths defined during the design phase. Business process rules may be defined during design and these static business rules control the flow of the business process. The process flows, once designed, may not be able to be modified in-flight and may require redeployment of the process to effect any changes to the flow.

### SUMMARY

In one embodiment, a method of dynamically modifying a process flow associated with an end to end process is disclosed. The method comprises receiving, by a dynamic business process engine, a trigger event associated with the end to end process; monitoring, by the dynamic business process engine, at least one process state resulting from the at least one trigger event; determining, by the dynamic business process engine, at least one of a user context, a process-event context, a process context, and an environment context for the at least one process state on detecting the at least one trigger event; defining, dynamically by the dynamic business process engine, one or more configurable business rules based on the at least one of the user context, the process-event context, the process context, and the environment context using artificial intelligence and machine learning; and performing, by the dynamic business process engine, a process state change based on the one or more configurable business rules.

In another embodiment, a dynamic business process engine for dynamically modifying a process flow associated with an end to end process is disclosed. The dynamic business process engine comprises one or more processors and a memory, wherein the memory coupled to the one or more processors which are configured to execute programmed instructions stored in the memory comprising: receiving a trigger event associated with the end to end process; monitoring at least one process state resulting from the at least one trigger event; determining at least one of a user context, a process-event context, a process context, and an environment context for the at least one process state on detecting the at least one trigger event; defining, dynamically, one or more configurable business rules based on the at least one of the user context, the process-event context, the process context, and the environment context using artificial intelligence and machine learning; and performing a process state change based on the one or more configurable business rules.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary environment with a dynamic business process engine for dynamically modifying a process flow associated with an end to end process in accordance with some embodiments of the present disclosure.

FIG. 2 is an exemplary functional block diagram of a plurality of modules present within a memory of the dynamic business process engine in accordance with some embodiments of the present disclosure.

FIG. 3 illustrates a flow diagram of a method of dynamically modifying the process flow associated with an end to end process in accordance with some embodiments of the present disclosure.

FIG. 4 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

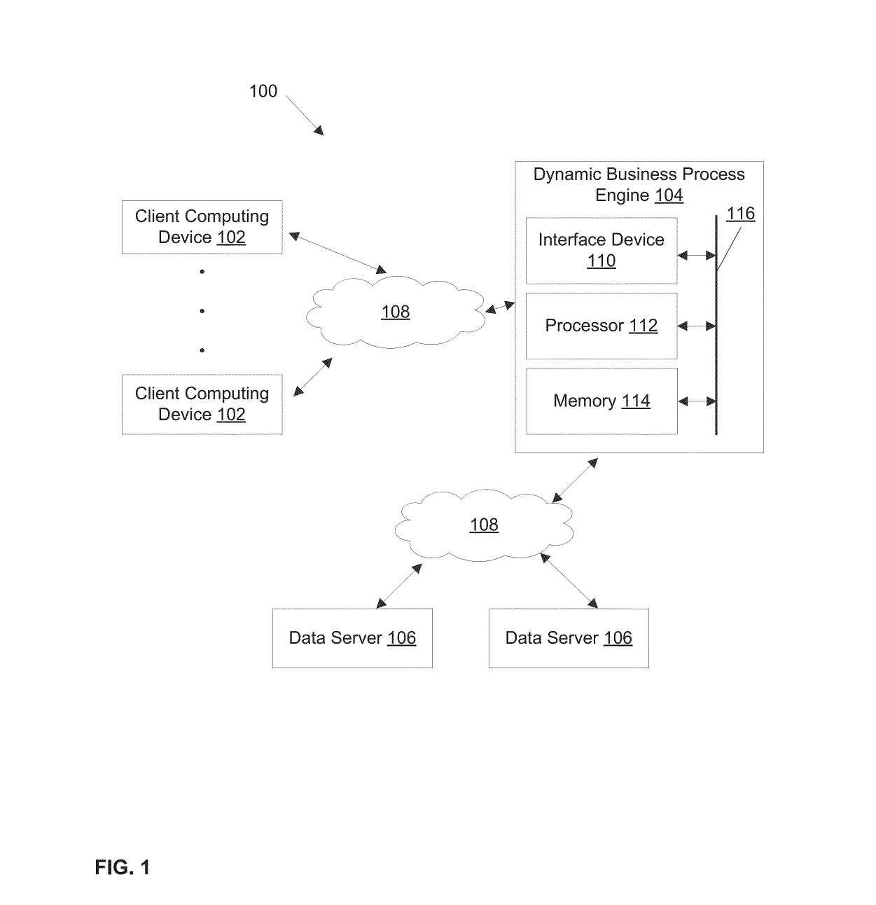

An exemplary environment 100 with a dynamic business process engine for dynamically modifying a process flow associated with an end to end process is illustrated in FIG. 1. The exemplary environment 100 includes a plurality of client computing devices 102, the dynamic business process engine 104, and data servers 106 which are coupled together by a communication network 108, although the environment can include other types and numbers of devices, components, elements, and communication networks 108 in other topologies and deployments. In some embodiments, dynamic business process engine 104 may be hosted on a cloud. While not shown, the exemplary environment 100 may include additional components, such as database etc, which are well known to those of ordinary skill in the art and thus will not be described here. This technology provides a number of advantages including providing more effective methods and devices for managing a business process flow.

Referring more specifically to FIG. 1, dynamic business process engine 104 is coupled to client computing devices 102 through the communication network 108, although the client computing devices 102 and dynamic business process engine 104 may be coupled together via other topologies. As it would be appreciated by a person having ordinary skill in the art, the communication network 108 may include one or more of mobile networks, local area network (LAN) or a wide area network (WAN), although the communication network 108 can include other topologies. Additionally, the dynamic business process engine 104 is coupled to the data servers 106 through the communication network 108, although the dynamic business process engine 104 and data servers 106 may be coupled together via other topologies.

The dynamic business process engine 104 assists with managing an end to end business process flow as illustrated and described with the examples herein, although dynamic business process engine 104 may perform other types and numbers of functions. The dynamic business process engine 104 includes an interface device 110, at least one CPU/processor 112, and memory 114 which are coupled together by bus 116, although dynamic business process engine 104 may comprise other types and numbers of elements in other configurations.

Processor(s) 112 may execute one or more computer-executable instructions stored in the memory 114 for the methods illustrated and described with reference to the examples herein, although the processor(s) can execute other types and numbers of instructions and perform other types and numbers of operations. The processor(s) 112 may comprise one or more central processing units (“CPUs”) or general purpose processors with one or more processing cores, such as AMD® processor(s), although other types of processor(s) could be used (e.g., Inter)).

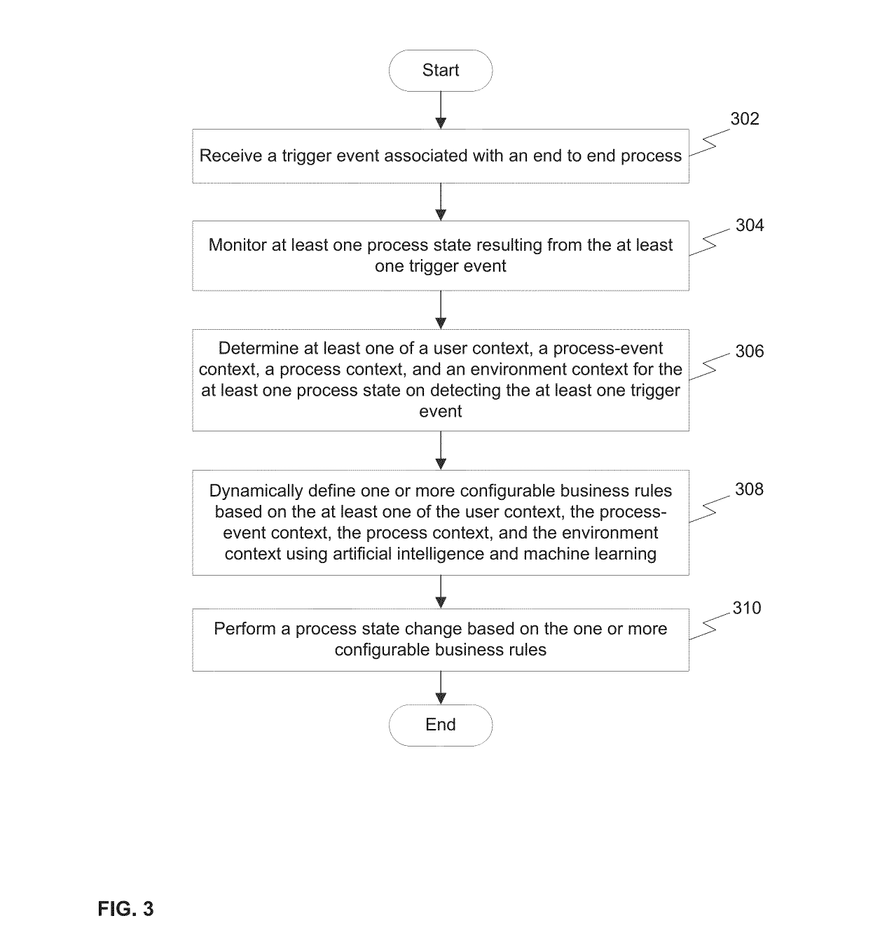

Memory 114 may comprise one or more tangible storage media, such as RAM, ROM, flash memory, CD-ROM, floppy disk, hard disk drive(s), solid state memory, DVD, or other memory storage types or devices, including combinations thereof, which are known to those of ordinary skill in the art. Memory 114 may store one or more non-transitory computer-readable instructions of this technology as illustrated and described with reference to the examples herein that may be executed by the one or more processor(s) 112. The flow chart shown in FIG. 3 is representative of example steps or actions of this technology that may be embodied or expressed as one or more non-transitory computer or machine readable instructions stored in memory 114 that may be executed by the processor(s) 112.

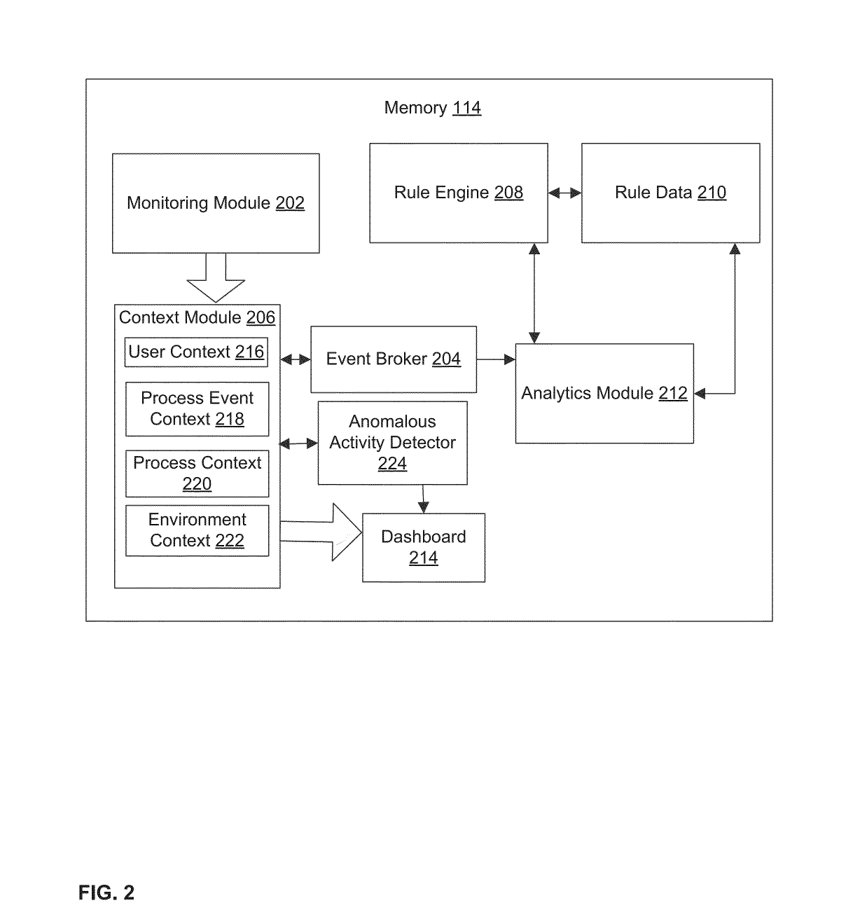

As illustrated in FIG. 2, memory 114 includes a monitoring module 202, an event broker 204, a context module 206, a rule engine 208, rule data 210, an analytics module 212, a dashboard 214, and an anomalous activity detector 224. Context module 206 may further include user context data 216, process-event data 218, process context data 220 and environment context data 222. Monitoring module 202 may monitor a process state associated with an end to end process. The process state may be a result of one or more trigger events received by dynamic business process engine 104. In general terms, a process state may correspond to a node in the business process flow. The trigger event may be an event that initiates an end to end process or that causes a state change from one state of the process to another. In this case, the trigger event may be received by dynamic business process engine 104 from various sources. In some embodiments, dynamic business process engine 104 may receive one or more trigger events from one or more users via one or more client devices such as client computing devices 102. For example, an employee of an organization may raise a leave request from one of a laptop computer, a desktop computer, a smartphone, a tablet, etc. Here, raising the leave request is a trigger event that may cause an initiation of an organizational process for handling the leave request. In some embodiments, the trigger event may be generated by one or more applications. For example, if a user creates a meeting request in a calendar application and the meeting is in a different city than the current city of the user, the calendar application may generate a trigger event either initiating a travel request process or may directly trigger a sub-process of the travel request process by booking flight tickets to the city in which the meeting is scheduled. In another embodiment, a trigger event may trigger other trigger events. Continuing with the ongoing example, the booking flight tickets trigger event may further trigger a “apply for a visa” event if the meeting involves travel to another country.

On the trigger of a process state, context module 206 may assist in determining context associated with the trigger event and the process state. Context module 206 may determine a user context, a process-event context, a process context, and an environment context. Context module 206 may determine context of the trigger event using user context data 216, process-event data 218, process context data 220 and environment context data 222. The user context data 216, the process-event data 218, process context data 220, and environment context data 222 may include predefined data as also dynamically updated data. The contextual data may be updated in real time to provide a more current context. User context data 216 may include user specific information of the user or employee associated with the trigger event. The user context data 216 may include role of the user in the organization, employee number of the user, position of the user in the organizational hierarchy, any special needs of the user, user's supervisor information, etc. Similarly, context module 206 may extract process-event context associated with the trigger event from process-event data 218. The process event data 218 may include data corresponding to the trigger event such as how often that trigger event has been generated by or tagged to the user, how the past occurrences of the event was handled, any exceptional conditions associated with the trigger event, etc. The context module 206 may further determine a process context associated with the process state. The process context may include various organization processes that govern the end to end process. In addition, the environment context of the process state may also be determined by context module 206. The environment context may include any environmental conditions that may require one or more business rules to be dynamically changed.

The context associated with the trigger event may be appended to the trigger event by context module 206 and passed on to the event broker 204. Event broker 204 may monitor and receive events via one or more of the following transports: Remote Method Invocation (RMI), Hypertext Transfer Protocol (HTTP), Java Message Service (JMS), Java Message Queue (JMQ), etc. The event broker 204 may parse the XML of the trigger event to determine event names to use for event configuration information. Event broker 204 may use the configuration information to determine appropriate actions to be taken for the event. For example, if an application is a registered listener for an event, event broker 204 notifies the listening application of the event. Event broker 204 may place the various trigger events on various queues and may notify the corresponding listening subscriber applications. In other words, event broker 204 may assist in orchestrating the one or more trigger events and the corresponding process state change. Event broker 204 may further ensure compliance with various Service Level Agreements (SLAs) associated with the trigger events such as high availability, high performance, no dropping of events, etc.

Analytics module 212 listens for events on the event broker 204. Analytics module 212 may receive the trigger event along with the contextual information associated with the trigger event and using artificial intelligence and machine learning techniques, analytics module 212 may define one or more business rules to process the one or more trigger events. In some embodiments, analytics module 212 may assist in adding a new business rule to existing business rules that govern the end to end process. In some other embodiments, analytics module 212 may remove one or more business rules existing for the end to end process or may modify one or more of the existing business rules based on the context associated with the trigger event.

One or more predefined configurable business rules for the end to end process may be stored as rule data 210. In some embodiments, depending on the context of the trigger event determined by context module 206, one or more of the predefined business rules may be selected and added as-is to the end to end process in real time. The business rules may then be processed by rule engine 208. In some other embodiments, the predefined configurable business rules may be modified or new rules generated by analytics module 212 depending on the context of the trigger event. For example, a travel process of an organization may dictate a process state wherein an employee has to raise a request for flight booking and then wait for approval from the concerned authority to confirm the booking. In this case, the context of the request may be determined. If the user context of the employee indicates that the user is a senior member of the organization and the flight selected by the user is a reasonably priced option (based on a history of flight prices to the selected destination and history of prices for the time booked by the user), then a new rule may be introduced that allows the user to proceed with the booking without needing to wait for approval. Thus, the process flow of the end to end process may be dynamically modified in real time by adding new rules, by deleting rules or by modifying parameters of existing rules. Analytics module 212 may employ artificial intelligence and machine learning techniques to suggest rule changes in real-time. For example, analytics module 212 may learn from past handling of various events and state changes and also based on manual feedback to appropriately handle events.

Once the analytics module 212 defines one or more business rules based on the context of the trigger event, rule engine 208 may execute the one or more business rules to cause a process state change to a subsequent state. Dynamic business process engine 104 may further include an Application Program Interface (API) hub to abstract process state functionalities as micro-services to be consumed by a consumer.

Memory 114 further includes anomalous activity detector 224 to detect anomalous activities associated with the end to end process by comparing real time activities of the user with the user context, the process-event context, the process context and the environment context. Anomalous activities in this case may refer to activities that deviate from a set norm for the end to end process. In some embodiments, the anomalous activity may correspond to a fraudulent activity. The anomalous activities may be detected in real time rather than after the event. For example, if the user submits an expense claim for expenses incurred during a business travel, but the location of the user (derived from context information) does not match with the location of the expenses, then anomalous activity detector 224 may flag this event as a potential fraudulent activity.

In some embodiments, anomalous activity detector 224 may display or render the anomalous activities on dashboard 214 to enable an administrator to take appropriate actions. Additionally, dashboard 214 may further render, in real time, the activities of the user and the contextual information associated with the event triggered by the user. Thus, the administrator may use dashboard 214 to manually control the various events and business rules associated with the end to end process.

A method of dynamically modifying a process flow associated with an end to end process will now be described in conjunction with FIG. 3. At step 302, a trigger event associated with the end to end process may be received by dynamic business process engine 104. The trigger event may be associated with the start of the end to end process or may be associated with a process state at the middle or the end of the end to end process. On receiving the trigger event, monitoring module 202 may monitor one or more process states resulting from the trigger event at step 304.

Thereafter, context module 206 may assist in determining context associated with the trigger event and the process state at step 306. Context module 206 may determine a user context, a process-event context, a process context, and an environment context. Context module 206 may determine context of the trigger event using user context data 216, process-event data 218, process context data 220 and environment context data 222 as described in conjunction with FIG. 2. The context associated with the trigger event may be appended to the trigger event by context module 206 and passed on to the event broker 204. The event broker 204 may parse the XML of the trigger event to determine event names to use for event configuration information. Event broker 204 may use the configuration information to determine appropriate actions to be taken for the event. Further, event broker 204 may assist in orchestrating the one or more trigger events and the corresponding process state change. Event broker 204 may also ensure compliance with various Service Level Agreements (SLAs) associated with the trigger events.

On determining the context information associated with the trigger event, one or more configurable business rules may be defined based on the contextual information associated with the trigger event and/or the process state at step 308. Analytics module 212 may receive the trigger event along with the contextual information associated with the trigger event and using artificial intelligence and machine learning techniques, analytics module 212 may define one or more business rules to process the one or more trigger events as explained in conjunction with FIG. 2.

Once the analytics module 212 defines one or more business rules based on the context of the trigger event, rule engine 208 may execute the one or more business rules to cause a process state change to a subsequent state at step 310. Dynamic business process engine 104 may further include an Application Program Interface (API) hub to abstract process state functionalities as micro-services to be consumed by a consumer.

Further, anomalous activities associated with the end to end process may be detected by anomalous activity detector 224 by comparing real time activities of the user with the user context, the process-event context, the process context and the environment context as described in conjunction with FIG. 2.

In some embodiments, the process flow of the end to end process may be manually controlled by an administrator. To enable this, dashboard 214 may render, in real time, the activities of the user and the contextual information associated with the event triggered by the user. The administrator may use the information rendered on dashboard 214 to manually control the process flow.

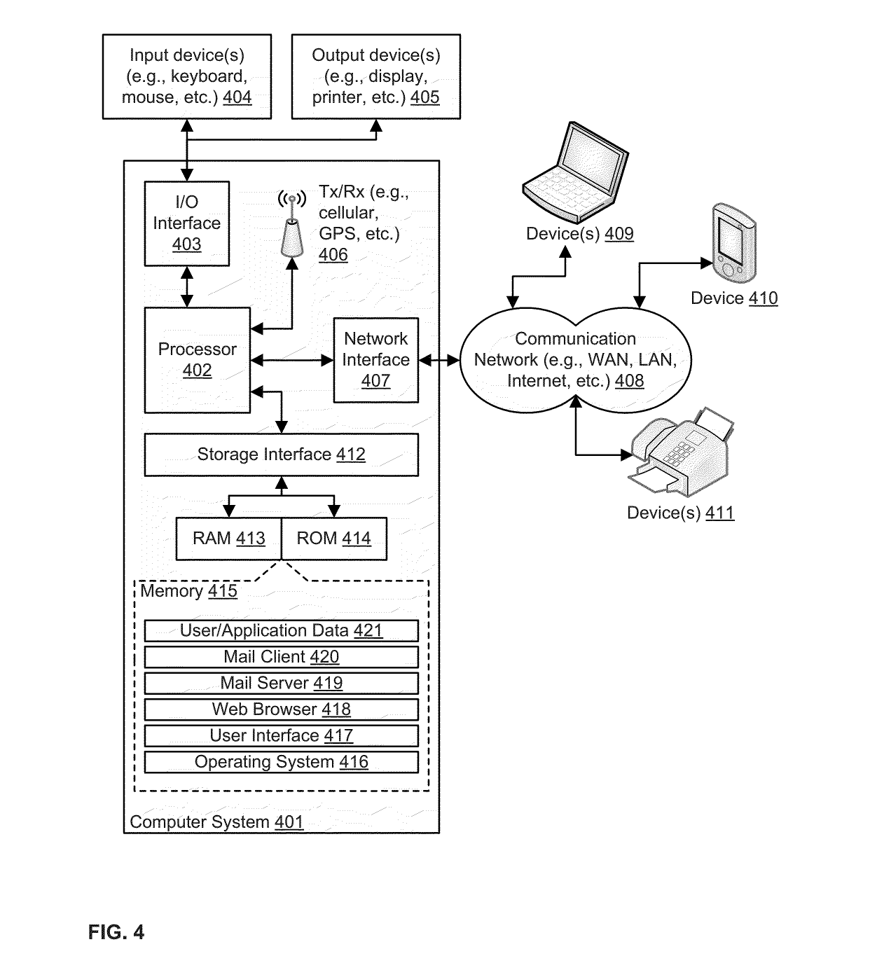

FIG. 4 is a block diagram of an exemplary computer system for implementing embodiments consistent with the present disclosure. Variations of computer system 401 may be used for implementing dynamic business process engine 104. Computer system 401 may comprise a central processing unit (“CPU” or “processor”) 402. Processor 402 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 410, 411, and 412. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 414, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 416, user interface application 417, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. (e.g., user context data, process-event context data, process context data, environment context data) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described a method and system for dynamically modifying a process flow associated with an end to end process. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of dynamically modifying a process flow associated with an end to end process, the method comprising:
receiving, by a dynamic business process engine, a trigger event associated with the end to end process;
monitoring, by the dynamic business process engine, at least one process state resulting from the at least one trigger event;
determining, by the dynamic business process engine, at least one of a user context, a process-event context, a process context, and an environment context for the at least one process state on detecting the at least one trigger event;
defining, dynamically by the dynamic business process engine, one or more configurable business rules based on the at least one of the user context, the process-event context, the process context, and the environment context using artificial intelligence and machine learning; and
performing, by the dynamic business process engine, a process state change based on the one or more configurable business rules.

2. The method of claim 1 further comprising abstracting process state functionalities as micro-services to be consumed by a consumer.

3. The method of claim 1 further comprising orchestrating the at least one trigger event and a corresponding process state change.

4. The method of claim 3, wherein the orchestration ensures compliance of Service Level Agreements (SLAs) associated with the end to end process.

5. The method of claim 1, further comprising detecting anomalous activities associated with the end to end process by comparing real time user activities with the at least one of the user context, the process-event context, the process context, and the environment context.

6. The method of claim 1, further comprising rendering one or more of the user activities, the user context, the process-event context, the process context, and the environment context on a dashboard.

7. The method of claim 1, wherein defining the one or more configurable business rules comprises at least one of adding a business rule, removing a business rule, and modifying a pre-defined business rule.

8. A dynamic business process engine for dynamically modifying a process flow associated with an end to end process comprising:
one or more processors;
a memory, wherein the memory coupled to the one or more processors which are configured to execute programmed instructions stored in the memory comprising:
receiving a trigger event associated with the end to end process;
monitoring at least one process state resulting from the at least one trigger event;
determining at least one of a user context, a process-event context, a process context, and an environment context for the at least one process state on detecting the at least one trigger event;
defining, dynamically, one or more configurable business rules based on the at least one of the user context, the process-event context, the process context, and the environment context using artificial intelligence and machine learning; and
performing a process state change based on the one or more configurable business rules.

9. The engine as set forth in claim 8 further comprising an Application Program Interface (API) hub to abstract process state functionalities as micro-services to be consumed by a consumer.

10. The engine as set forth in claim 8 further comprising an event broker to orchestrate the at least one trigger event and a corresponding process state change.

11. The engine as set forth in claim 10, wherein the orchestration ensures compliance of Service Level Agreements (SLAs) associated with the end to end process.

12. The engine as set forth in claim 8, wherein the programmed instructions further comprise instructions to detect anomalous activities associated with the end to end process by comparing real time user activities with the at least one of the user context, the process-event context, the process context, and the environment context.

13. The engine as set forth in claim 8 further comprising a dashboard to render one or more of the user activities, the user context, the process-event context, the process context, and the environment context.

14. The engine as set forth in claim 8, wherein defining the one or more configurable business rules comprises at least one of adding a business rule, removing a business rule, and modifying a pre-stored business rule.

15. A non-transitory computer readable medium having stored thereon instructions for dynamically modifying a process flow associated with an end to end process comprising machine executable code which when executed by at least one processor, causes the processor to perform steps comprising:
receiving a trigger event associated with the end to end process;
monitoring at least one process state resulting from the at least one trigger event;
determining at least one of a user context, a process-event context, a process context, and an environment context for the at least one process state on detecting the at least one trigger event;
defining, dynamically, one or more configurable business rules based on the at least one of the user context, the process-event context, the process context, and the environment context using artificial intelligence and machine learning; and
performing a process state change based on the one or more configurable business rules.

16. The medium as set forth in claim 15 further comprising instructions for abstracting process state functionalities as micro-services to be consumed by a consumer.

17. The medium as set forth in claim 15 further comprising instructions for orchestrating the at least one trigger event and a corresponding process state change.

18. The medium as set forth in claim 15 further comprising instructions for detecting anomalous activities associated with the end to end process by comparing real time user activities with the at least one of the user context, the process-event context, the process context, and the environment context.

19. The medium as set forth in claim 15 further comprising instructions for rendering one or more of the user activities, the user context, the process-event context, the process context, and the environment context on a dashboard.

20. The medium as set forth in claim 15, wherein defining the one or more configurable business rules comprises at least one of adding a business rule, removing a business rule, and modifying a pre-defined business rule.
